(19) United States
(12) Patent Application Publication
(10) Pub. No.: US 2025/0389244 A1
(43) Pub. Date: Dec. 25, 2025

(54) FUEL INJECTOR OF AN INTERNAL COMBUSTION ENGINE AND INTERNAL COMBUSTION ENGINE

(71) Applicant: MAN Energy Solutions SE, Augsburg (DE)

(72) Inventor: Maximilian INDRICH, Bobingen (DE)

(21) Appl. No.: 19/240,165

(22) Filed: Jun. 17, 2025

(30) Foreign Application Priority Data
Jun. 21, 2024 (DE) 10 2024 117 521.4

(51) Int. Cl. F02M 43/04; F02M 63/00

(52) U.S. Cl. CPC F02M 43/04; F02M 63/0031

(57) ABSTRACT

A fuel injector of an internal combustion engine, having a first nozzle needle guided in a first needle guide, which interacts with first fuel injection orifices such that the first nozzle needle either opens or blocks flow of a first fuel through the first fuel injection orifices, a second nozzle needle guided in a second needle guide, which interacts with second fuel injection orifices such that the second nozzle needle either opens or blocks flow of a second fuel through the second fuel injection orifices, a first solenoid valve controls the first nozzle needle, a second solenoid valve controls the second nozzle needle. The first and second solenoid valve are integrated in the fuel injector such that the first and second solenoid valves are each arranged in the longitudinal or axial direction of the fuel injector between the nozzle needles and a fuel storage space of the fuel injector.

### BACKGROUND OF THE INVENTION

### 1. Field of the Invention

The disclosure relates to a fuel injector of an internal combustion engine. Further, the disclosure relates to an internal combustion engine having at least one fuel injector.

The disclosure present here relates in particular to the field of so-called large engines or large internal combustion engines, the cylinders of which have piston diameters of at least 140 millimetre, in particular of at least 175 millimetre. Such large internal combustion engines are, for example, ships' engines. Dual-fuel internal combustion engines as ships' engines are already known. Dual-fuel internal combustion engines known from practise can be operated in a first operating mode, which combust a first fuel, in particular a relatively ignitable fuel, and in a second operating mode, which combust a second fuel, in particular a relatively less-ignitable fuel. The first, relatively ignitable fuel can be, for example, a diesel fuel. The second, relatively less-ignitable fuel can be, for example, methanol, ethanol, or ammonia. In the second operating mode, the second, relatively less-ignitable fuel, in particular the methanol, ethanol, or ammonia, can be ignited via the first, relatively ignitable fuel, in particular the diesel fuel.

### 2. Description of Related Art

DE 10 2013 000 048 B3 discloses a fuel injector, with the help of which both a first, relatively ignitable fuel and also a second, relatively less-ignitable fuel can be introduced into a combustion chamber of a cylinder.

### SUMMARY OF THE INVENTION

Starting out from this, one aspect of the present invention is a new type of fuel injector of an internal combustion engine and an internal combustion engine having such a fuel injector.

The fuel injector comprises a first nozzle needle moveably guided in a first nozzle guide, which nozzle needle interacts with first fuel injection orifices in such a manner that the first nozzle needle, dependent on its position, either opens or blocks a fuel flow of a first fuel through the first fuel injection orifice. The fuel injector, further, comprises a second nozzle needle moveably guided in a second needle guide, which nozzle needle interacts with second fuel injection orifices in such a manner that the second nozzle needle, dependent on its position, either opens or blocks a fuel flow of a second fuel through the second fuel injection orifices. The fuel injector according to one aspect of the invention, further, comprises a first solenoid valve integrated in the fuel injector, for controlling the first nozzle needle and a second solenoid valve integrated in the fuel injector for controlling the second nozzle needle, wherein the first and second solenoid valve are integrated in the fuel injector in such a manner that the first and second solenoid valve, in the longitudinal direction or axial direction of the fuel injector, are each arranged between the nozzle needles and at least one fuel storage space of the fuel injector, preferentially between the two nozzle needles and the fuel storage spaces for the first and second fuel integrated in the fuel injector. The invention provides a complete installation space-saving embodiment of a fuel injector for two different fuels.

Both solenoid valves are integrated in the fuel injector, namely in such a manner that the two solenoid valves are arranged in the longitudinal direction or axial direction of the motor vehicle between the nozzle needles and at least one fuel storage space of the fuel injector. Accordingly, a distance between the solenoid valves and the nozzle needles is minimised.

The distance between the two solenoid valves and the respective nozzle needle is then shortest when the two solenoid valves are integrated in the fuel injector in such a manner that the two solenoid valves, in the transverse direction or radial direction of the fuel injector, are integrated in the fuel injector laterally next to one another, namely in such a manner that the same overlap in the longitudinal direction or axial direction of the fuel injector, however, not in the transverse direction or radial direction.

Preferentially, a longitudinal axis of a control pin of the first solenoid valve and a longitudinal axis of a control pin of the second solenoid valve run parallel to one another and parallel to a longitudinal centre axis of the fuel injector. Likewise, a longitudinal axis of the first nozzle needle and a longitudinal axis of the second nozzle needle run parallel to one another and parallel to the longitudinal centre axis of the fuel injector. This is particularly preferred for a compact, simple design of the fuel injector.

It can be provided that the longitudinal axis of the control pin of the first solenoid valve runs coaxially to the longitudinal axis of the first nozzle needle and also the longitudinal axis of the control pin of the second solenoid valve coaxially to the longitudinal axis of the second nozzle needle. In particular when the control pin of the first solenoid valve runs coaxially to the first nozzle needle and the control pin of the second solenoid valve coaxially to the second nozzle needle, a particularly simple fuel injector is possible with compact design.

Alternatively it can be provided that the longitudinal axis of the control pin of the first solenoid valve is offset relative to the longitudinal axis of the first nozzle needle and/or the longitudinal axis of the control pin of the second solenoid valve relative to the longitudinal axis of the second nozzle needle.

In particular when the longitudinal axis of the control pin of the first solenoid valve is offset relative to the longitudinal axis of the first nozzle needle, a ratio C1/CA between the distance C1 between the longitudinal axis of the control pin of the first solenoid valve relative to the longitudinal axis of the first nozzle needle and the distance CA between the longitudinal axes of the control pins of the two solenoid valves amounts to between 0.05 and 0.25, and/or a ratio C1/CB between the distance C1 between the longitudinal axis of the control pin of the first solenoid valve relative to the longitudinal axis of the first nozzle needle and the distance CB between the longitudinal axes of the two nozzle needles amounts to between 0.05 and 0.25. In particular when the longitudinal axis of the control pin of the second solenoid valve is offset relative to the longitudinal axis of the second nozzle needle, a ratio C2/CA between the distance C2 between the longitudinal axis of the control pin of the second solenoid valve relative to the longitudinal axis of the second nozzle needle and the distance CA between the longitudinal axes of the control pins of the two solenoid valves amounts to between 0.05 and 0.25, and/or a ratio C2/CB between the distance C2 between the longitudinal axis of the control pin of the second solenoid valve relative to the longitudinal axis of the second nozzle needle and the distance CB between the longitudinal axes of the two nozzle needles amounts to between 0.05 and 0.25. In particular when the control pin of the first solenoid valve is offset relative to the first nozzle needle and/or the control pin of the second solenoid valve relative to the second nozzle needle, a simple embodiment of the fuel injector can likewise be ensured with minimal installation space requirement.

Preferentially, control bores for controlling the first nozzle needle extend emanating from the first solenoid valve and control bores for controlling the second nozzle needle, extend emanating from the second solenoid valve via a common control plate of the fuel injector, which is arranged between a nozzle needle receiving body of the fuel injector receiving the two nozzle needles and a solenoid valve receiving body of the fuel injector receiving at least one of the two solenoid valves, preferentially both solenoid valves. This also serves for providing a fuel injector of simple and compact design for two different fuels.

Preferred further developments of the invention are obtained from the subclaims and the following description.

### BRIEF DESCRIPTION OF THE DRAWINGS

Exemplary embodiments of the invention are explained in more detail by way of the drawing without being restricted to this. There it shows:

FIG. 1: is a cross-section in the longitudinal direction or axial direction through a fuel injector; and

FIG. 2: is a cross-section of the longitudinal direction or axial direction through a fuel injector.

### DETAILED DESCRIPTION OF THE PRESENTLY PREFERRED EMBODIMENTS

One aspect of the invention relates to a fuel injector of an internal combustion engine. Such a fuel injector is designed for supplying fuel to a combustion chamber of a cylinder of the internal combustion engine.

The fuel injector according to one aspect of the invention serves for supplying different fuels to an internal combustion engine designed in particular as dual-fuel internal combustion engine, namely a first, relatively ignitable fuel in a first operating mode and a second, relatively less-ignitable fuel in a second operating mode and igniting the first, relatively ignitable fuel in order to ignite the second, relatively less-ignitable fuel via the first, relatively ignitable fuel.

The first, relatively ignitable fuel is in particular a diesel fuel. The second, relatively less-ignitable fuel can be methanol, ethanol or ammonia.

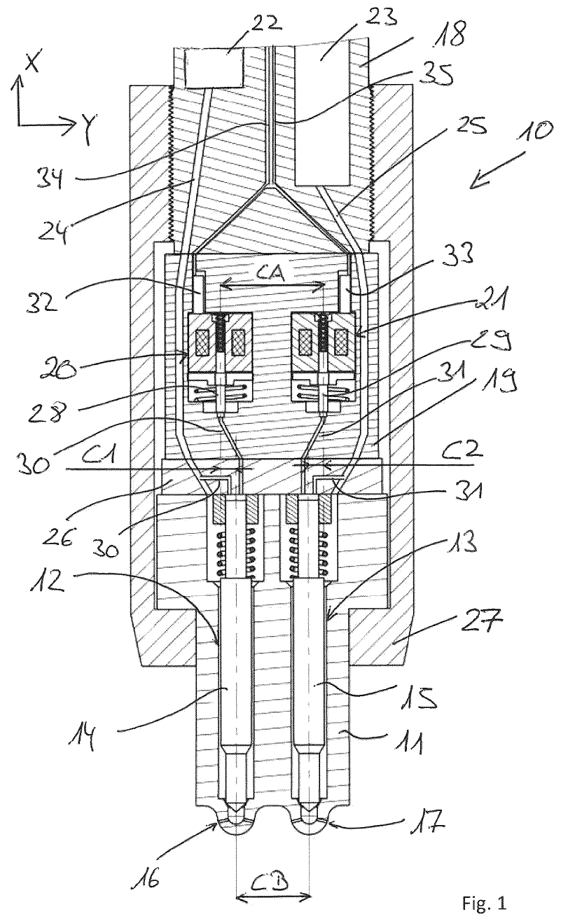

FIG. 1 shows a cross-section through a first fuel injector 10 according to one aspect of the invention, wherein the fuel injector 10 comprises a nozzle needle receiving body 11, which provides a first nozzle guide 12 for a first nozzle needle 14 and a second nozzle guide 13 for a second nozzle needle 15. Further, the nozzle needle receiving body 11 provides first fuel injection orifices 16 and second fuel injection orifices 17. Dependent on the position of the nozzle needles 14, 15, the same open or block a fuel flow through the fuel injection orifices 16, 17.

The fuel injector 10 according to one aspect of the invention, further, comprises a fuel storage space receiving body 18 and in the exemplary embodiment of FIG. 1 a solenoid valve receiving body 19 arranged between the fuel storage space receiving body 18 and the nozzle needle receiving body 11.

A first solenoid valve 20 arranged in the solenoid valve receiving body 19 serves for controlling the first nozzle needle 14, in order to either open or block the fuel flow through the first fuel injection orifices 16 by changing the position of the first nozzle needle 14. A second solenoid valve 21 arranged in the solenoid valve receiving body 19 serves for controlling the second nozzle needle 15, in order to change the position of the second nozzle needle 15 and, dependent thereon, either open or block the fuel flow of the second fuel through the second fuel injection orifices 17.

As already explained, the fuel injector 10 comprises the fuel storage space receiving body 18. In the fuel injector 10, namely in the fuel storage space receiving body 18 of the same, a first fuel storage space 22 for the first fuel and a second fuel storage space 23 for the second fuel are preferentially integrated.

The at least one first fuel storage space 22 of the fuel injector 10 according to one aspect of the invention is connected via a first fuel line 24 and the at least one second fuel storage space 23 of the fuel injector 10 according to the invention via a second fuel line 25 to the nozzle needle receiving body 11, wherein these fuel lines 24, 25, emanating from the fuel storage space receiving body 18, extend via the solenoid valve receiving body 19 and preferentially a plate-like intermediate body 26 arranged between the solenoid valve receiving body 19 and the nozzle needle receiving body 11, in the direction of the nozzle needle receiving body 11. The intermediate body 26 is referred to as control plate in the following.

FIG. 1, further, shows a sleeve body 27, wherein the solenoid valve receiving body 19 and the control plate 26 are completely, and the nozzle needle receiving body 11 and the fuel storage space receiving body 18, partially arranged within the sleeve body 27. By way of the sleeve body 27, the fuel injector 10 can be assembled, for example, in a corresponding recess in a cylinder head of a cylinder of the internal combustion engine.

In the fuel injector 10 according to one aspect of the invention, both the first solenoid valve 20 of the same for the first fuel and also the second solenoid valve 21 of the same for the second fuel are both integrated in the fuel injector 10, namely the solenoid valve receiving body 19, namely in such a manner that the first solenoid valve 20 and the second solenoid valve 21 are each arranged in the longitudinal direction or axial direction X of the fuel injector 10 between the nozzle needles 14, 15 and the at least one fuel space of the fuel injector 10. In the exemplary embodiment of FIG. 1, both solenoid valves 20, 21 are arranged between the two nozzle needles 14, 15 for the two different fuels and the two fuel storage spaces 22, 23 for the two different fuels.

In the exemplary embodiment of FIG. 1, the two solenoid valves 20, 21 are integrated in the fuel injector 10 next to one another in the radial direction or transverse direction of the fuel injector 10, namely in such a manner that the same overlap in the longitudinal direction or axial direction X of the fuel injector 10, however, not in the transverse direction or radial direction Y of the fuel injector 10. In this case, the two solenoid valves 20, 21 are received in a common solenoid valve receiving body 19.

As is evident from FIG. 1, the longitudinal axes of the two nozzle needles 14, 15 run parallel to one another and parallel to a longitudinal centre axis of the fuel injector 10, wherein the two longitudinal axes of the two nozzle needles 14, 15.

With the distance CB, FIG. 1 shows the distance between the longitudinal axes of the two nozzle needles 14, 15 of the fuel injector 10.

Each of the solenoid valves 20, 21 of the fuel injector 10 comprises a control pin 28 and 29 respectively, wherein according to FIG. 1 a longitudinal axis of the control pin 28 of the first solenoid valve 20 runs parallel to a longitudinal axis of the control pin 29 of the second solenoid valve 21, both of which in turn run parallel to the longitudinal centre axis of the fuel injector 10.

With the distance CA, FIG. 1 shows the distance between the longitudinal axes of the two control pins 28, 29 of the two solenoid valves 20, 21 of the fuel injector 10.

In FIG. 1, the distance CA is greater than the distance CB. However, the distance CA can also correspond to the distance CB. It is also possible that the distance CA is smaller than the distance CB. The ratio CA/CB can amount to between 0.75 and 1.25.

In particular when the distance CA corresponds to the distance CB, the longitudinal axis of the control pin 28 of the first solenoid valve 20 runs coaxially to the longitudinal axis of the first nozzle needle 14 of the fuel injector 10, and the longitudinal axis of the control pin 29 of the second solenoid valve 21 runs coaxially to the longitudinal axis of the second nozzle needle 15 of the fuel injector 10.

In FIG. 1, the longitudinal axis of the control pin 28 of the first solenoid valve 20 of the fuel injector 10 is offset relative to the longitudinal axis of the first nozzle needle 14 in the transverse direction or radial direction Y of the fuel injector 10, wherein C1 corresponds to the distance between the longitudinal axis of the control pin 28 of the first solenoid valve 20 and the longitudinal axis of the first nozzle needle 14. Likewise, the longitudinal axis of the control pin 29 of the second solenoid valve 21 of the fuel injector 10 is offset relative to the longitudinal axis of the second nozzle needle 15 in FIG. 1, wherein C2 corresponds to the distance between the longitudinal axis of the control pin 29 of the second solenoid valve 21 and the longitudinal axis of the second nozzle needle 15.

In particular when the longitudinal axis of the control pin 28 of the first solenoid valve 20 of the fuel injector 10 is offset relative to the longitudinal axis of the first nozzle needle 14 of the fuel injector 10, the ratio C1/CA amounts to between 0.05 and 0.25 and/or the ratio C1/CB to between 0.05 and 0.25. The ratio C1/CA is in particular smaller than the ratio C1/CB. The ratios can also be equal in size.

In particular when the longitudinal axis of the control pin 29 of the second solenoid valve 21 of the fuel injector 10 is offset relative to the longitudinal axis of the second nozzle needle 15 of the fuel injector 10, the ratio C2/CA preferentially amounts to between 0.05 and 0.25 and/or the ratio C2/CB to between 0.05 and 0.25. In FIG. 1, the ratio C2/CA is smaller than the ratio C2/CB. The two ratios can also be equal in size.

As already explained, the control plate 26 is arranged in FIG. 1 between the nozzle needle receiving body 11 receiving the two nozzle needles 14, 15 and the solenoid valve receiving body 19 receiving the two solenoid valves 20, 21, through which control plate 26 the fuel lines 24, 25 extend, likewise control lines 30, 31, via which the solenoid valves 20, 21 control the nozzle needles 14, 15. This allows a compact and particularly simple design of the fuel injector 10.

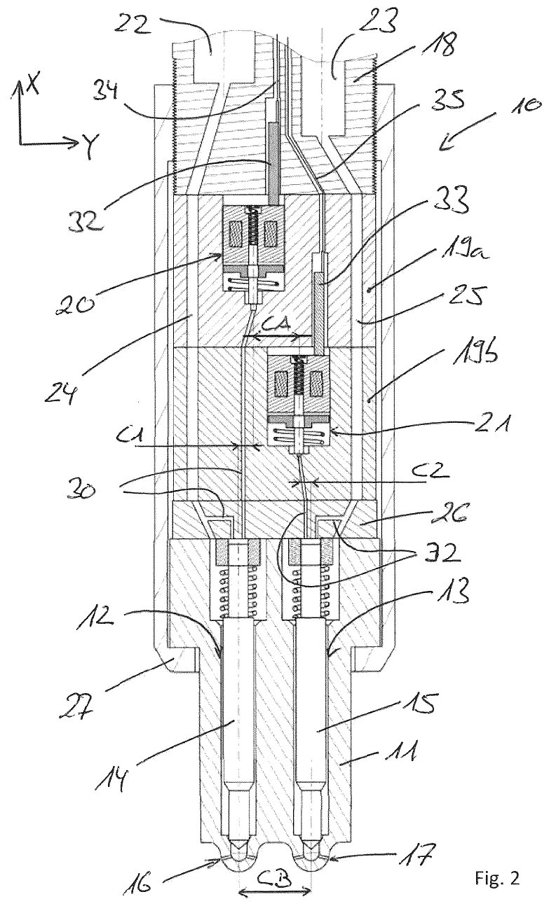

A modification of the fuel injector 10 according to one aspect of the invention is shown in FIG. 2. In FIG. 2, the two solenoid valves 20, 21 are integrated in the fuel injector 10 between the two nozzle needles 14, 15 and the fuel storage spaces 22, 23 in such a manner that the two solenoid valves 20, 21 are arranged in the longitudinal direction or axial direction X one behind the other, so that the same partially overlap in the transverse direction or radial direction Y, however, not in the longitudinal direction or axial direction X. According to FIG. 2, a separate solenoid valve receiving body 19a, 19b is present for each of the solenoid valves 20, 21 respectively, which are likewise arranged in the longitudinal direction or axial direction X of the fuel injector 10 one behind the other. With respect to all remaining details, the fuel injector 10 of FIG. 2 corresponds to the fuel injector 10 of FIG. 1, so that to avoid repetitions, same reference numbers are used for same assemblies and reference is made to the explanations regarding the fuel injector 10 of FIG. 1.

Accordingly, in both exemplary examples, both solenoid valves 20, 21, which interact with the nozzle needles 14, 15 for the different fuels, are integrated in the fuel injector 10, namely in at least one solenoid valve receiving body 19 and 19a, 19b respectively, which is arranged between the nozzle needle receiving body 11 and the storage space receiving body 18. In FIG. 1, the solenoid valves 20, 21 are arranged next to one another in the transverse direction Y, and one behind the other in the axial direction X in FIG. 2. Control lines 30, 31 and fuel lines 24, 25 extend each in sections through a common control plate 26.

Controlling the solenoid valves 20, 21 takes place via electrical cables and plug connectors. FIGS. 1 and 2 show for the first solenoid valve 20 an electrical plug connector 32 and for the second solenoid valve 21 an electrical plug connector 33. Electrical cables 34, 35, which extend through corresponding recesses in the storage space receiving body 18 and the at least one solenoid valve receiving body 19 and 19a, 19b respectively lead to these plug connectors 32, 33. The installation space needed for electrically contacting the solenoid valves 20, 21 is provided in particular through the offset of the solenoid valves 20, 21 in the transverse direction Y.

Thus, while there have shown and described and pointed out fundamental novel features of the invention as applied to a preferred aspect thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. A fuel injector of an internal combustion engine which is designed for supplying fuel to a combustion chamber of a cylinder of the internal combustion engine, comprising:
a first nozzle needle moveably guided in a first nozzle guide, which interacts with first fuel injection orifices such that the first nozzle needle, dependent on its position either opens or blocks a fuel flow of a first fuel through the first fuel injection orifices;
a second nozzle needle that is moveably guided in a second needle guide, which interacts with second fuel injection orifices in such a manner that the second nozzle needle, dependent on its position either opens or blocks a fuel flow of a second fuel through the second fuel injection orifices;
a first solenoid valve integrated in the fuel injector configured to control the first nozzle needle; and
a second solenoid valve integrated in the fuel injector configured to control the second nozzle needle,
wherein the first and the second solenoid valve are integrated in the fuel injector such that the first and second solenoid valve are each arranged in a longitudinal direction or an axial direction of the fuel injector between the first and second nozzle needles and at least one fuel storage space of the fuel injector.

2. The fuel injector according to claim 1,
wherein the first and second solenoid valve are integrated in the fuel injector such that the two solenoid valves are arranged in the longitudinal direction or the axial direction of the fuel injector between the two nozzle needles and fuel storage spaces integrated in the fuel injector for the first and second fuel.

3. The fuel injector according to claim 1,
wherein the first solenoid valve and the second solenoid valve are integrated in the fuel injector in a transverse direction or a radial direction of the fuel injector laterally next to one another such that the first solenoid valve and the second solenoid valve overlap in the longitudinal direction or the axial direction of the fuel injector but not in the transverse direction or the radial direction of the fuel injector.

4. The fuel injector according to claim 1,
wherein the first solenoid valve and the second solenoid valve are integrated in the fuel injector in the longitudinal direction or the axial direction of the fuel injector one behind the other such that the first solenoid valve and the second solenoid valve partially overlap in a transverse direction or a radial direction of the fuel injector but not in the longitudinal direction or the axial direction of the fuel injector.

5. The fuel injector according to claim 1,
wherein a longitudinal axis of a control pin of the first solenoid valve and a longitudinal axis of a control pin of the second solenoid valve run parallel to one another.

6. The fuel injector according to claim 5,
wherein the longitudinal axis of the control pin of the first solenoid valve runs coaxially to a longitudinal axis of the first nozzle needle and/or the longitudinal axis of the control pin of the second solenoid valve coaxially to a longitudinal axis of the second nozzle needle.

7. The fuel injector according to claim 5,
wherein the longitudinal axis of the control pin of the first solenoid valve is offset relative to a longitudinal axis of the first nozzle needle and/or the longitudinal axis of the control pin of the second solenoid valve relative to a longitudinal axis of the second nozzle needle.

8. The fuel injector according to claim 7,
wherein a ratio C1/CA between a distance C1 between the longitudinal axis of the control pin of the first solenoid valve relative to the longitudinal axis of the first nozzle needle and a distance CA between the longitudinal axes of the control pins of the two solenoid valves amounts to between 0.05 and 0.25, and/or wherein a ratio C2/CA between a distance C2 between the longitudinal axis of the control pin of the second solenoid valve relative to the longitudinal axis of the second nozzle needle and the distance CA between the longitudinal axes of the control pins of the two solenoid valves amounts to between 0.05 and 0.25.

9. The fuel injector according to claim 7,
wherein a ratio C1/CB between a distance C1 between the longitudinal axis of the control pin of the first solenoid valve relative to the longitudinal axis of the first nozzle needle and a distance CB between the longitudinal axes of the first and second nozzle needles amounts to between 0.05 and 0.25, and/or
wherein a ratio C2/CB between a distance C2 between the longitudinal axis of the control pin of the second solenoid valve relative to the longitudinal axis of the second nozzle needle and the distance CB between the longitudinal axes of the two nozzle needles amounts to between 0.05 and 0.25.

10. The fuel injector according to claim 1,
wherein a control line configured to control the first nozzle needle emanating from the first solenoid valve and a control line configured to control the second nozzle needle emanating from the second solenoid valve extend over a common control plate of the fuel injector, which is arranged between a nozzle needle receiving body of the fuel injector receiving the two nozzle needles and a solenoid valve receiving body receiving at least one of the two solenoid valves, preferentially both solenoid valves of the fuel injector.

11. The fuel injector according to claim 2,
wherein when the first solenoid valve and the second solenoid valve are integrated in the fuel injector laterally next to one another, both solenoid valves are received in a common solenoid valve receiving body of the fuel injector.

12. The fuel injector according to claim 3,
wherein when the first solenoid valve and the second solenoid valve are integrated in the fuel injector one behind the other, both solenoid valves are each received in their own solenoid valve receiving body of the fuel injector.

13. An internal combustion engine, having cylinders, wherein each cylinder comprises a fuel injector designed for supplying fuel to a combustion chamber of a respective cylinder of the internal combustion engine, comprising:
a first nozzle needle moveably guided in a first nozzle guide, which interacts with first fuel injection orifices such that the first nozzle needle, dependent on its position either opens or blocks a fuel flow of a first fuel through the first fuel injection orifices;
a second nozzle needle that is moveably guided in a second needle guide, which interacts with second fuel injection orifices in such a manner that the second nozzle needle, dependent on its position either opens or blocks a fuel flow of a second fuel through the second fuel injection orifices;
a first solenoid valve integrated in the fuel injector configured to control the first nozzle needle; and
a second solenoid valve integrated in the fuel injector configured to control the second nozzle needle,
wherein the first and the second solenoid valve are integrated in the fuel injector such that the first and second solenoid valve are each arranged in a longitudinal direction or an axial direction of the fuel injector between the first and second nozzle needles and at least one fuel storage space of the fuel injector.
